(19) United States
(12) Patent Application Publication
(10) Pub. No.: US 2016/0353406 A1
(43) Pub. Date: Dec. 1, 2016

(54) MEDIA INFORMATION SHARING BETWEEN NETWORKED MOBILE DEVICES

(71) Applicant: TRUMPIT, INC., Winchester, MA (US)

(72) Inventors: Vasileios J. GIANOUKOS, Winchester, MA (US); Carl Elie NEHME, Boston, MA (US); Nicholas James LIZOTTE, West Boylston, MA (US)

(21) Appl. No.: 15/077,573

(22) Filed: Mar. 22, 2016

Related U.S. Application Data
(60) Provisional application No. 62/166,189, filed on May 26, 2015.

(51) Int. Cl. H04W 68/00; H04W 4/06; H04W 4/12

(52) U.S. Cl. CPC H04W 68/005; H04W 4/12; H04W 4/06; H04W 88/02

(57) ABSTRACT

The embodiments disclosed herein can provide a user-friendly media sharing mechanism for sharing media information amongst multiple mobile devices over a communication network. In particular, the disclosed media sharing mechanism can enable a mobile device to display the media information above the lock-screen native to the operating system (e.g., provided as part of the operating system) on an on-demand basis. For example, when a user receives media information at a mobile device, the mobile device can display the media information above the lock-screen native to the operating system.

### CROSS-REFERENCE TO RELATED APPLICATION

This application claims benefit of the earlier priority date of U.S. Provisional Application No. 62/166,189, entitled “SHARING OF MEDIA INFORMATION BETWEEN NETWORKED MOBILE DEVICES,” filed on May 26, 2015, by Gianoukos et al., which is herein incorporated by reference in its entirety.

### FIELD OF THE DISCLOSURE

This disclosure relates generally to sharing media information over a communication network using mobile devices.

### BACKGROUND

Mobile devices can include functionalities for sharing media information, such as images, videos, and/or text. For example, mobile devices can share media information using a Short Message Service (SMS). As another example, mobile devices can use image sharing applications to capture digital images and share them with followers or send them through direct messages to targeted users. As used herein, “media” includes, without limitation, audio/video, animation, text and still images, but also multimedia and any other forms of digital media.

### SUMMARY

Some embodiments include a method for providing media information at a mobile device. The method can include receiving, at a lock screen listener module of a mobile device, a notification from a receiver module, indicating that media information has been received from a communications network, and in response to receiving the notification, instructing, by the lock screen listener module, a lock screen display module to display the media information above a lock screen on a display of the mobile device.

In some embodiments, the method also includes monitoring a Multimedia Messaging Service (MMS) stack, by the lock screen listener module, to determine whether the media information has been received from the communications network.

In some embodiments, the method also includes intercepting a message on the MMS stack to retrieve the media information.

In some embodiments, instructing the lock screen display module to display the media information includes providing the media information to the lock screen display module.

In some embodiments, the receiver module includes a software application running independently of the lock screen listener module and the lock screen display module.

In some embodiments, the method also includes providing interactive tools for editing the media information displayed above the lock screen.

In some embodiments, the method also includes comprising sending the edited media information to another mobile device over the communications network.

In some embodiments, the method also includes sending the edited media information to a group of mobile devices over the communications network.

Some embodiments include a mobile device configured to provide media information received from a communications network. The mobile device includes a display configured to display a lock screen and media information. The mobile device also includes non-transitory memory storing computer readable instructions associated with a receiver module, a lock screen listener module and a lock screen display module. The mobile device also includes one or more interfaces for receiving the media information from the communications network. Additionally, the mobile device includes a processor in communication with the one or more interfaces and the non-transitory memory. The computer readable instructions are configured to cause the processor to receive, at the lock screen listener module, a notification from the receiver module, indicating that media information has been received from a communications network; and in response to receiving the notification, instruct, by the lock screen listener module, the lock screen display module to display the media information above the lock screen on the display.

In some embodiments, the computer readable instructions are configured to cause the processor to monitor a MMS stack, by the lock screen listener module, to determine whether media information has been received from the communication network.

In some embodiments, the computer readable instructions are configured to cause the processor to intercept a message on the MMS stack to retrieve the media information.

In some embodiments, the computer readable instructions are configured to cause the processor to provide the media information to the lock screen display module to instruct the lock screen display module to display the media information above the lock screen on the display.

In some embodiments, the receiver module includes a software application running independently of the lock screen listener module and the lock screen display module.

In some embodiments, the computer readable instructions are configured to cause the processor to instruct the lock screen display module to display the media information over the entire lock screen.

In some embodiments, the computer readable instructions are configured to cause the processor to provide interactive tools for editing the media information displayed above the lock screen.

In some embodiments, the computer readable instructions are configured to cause the processor to send the edited media information to another mobile device via the one or more interfaces over the communications network.

In some embodiments, the computer readable instructions are configured to cause the processor to send the edited media information to a group of mobile devices via the one or more interfaces over the communications network.

Some embodiments include a non-transitory computer readable medium having executable instructions for providing media information. The executable instructions are operable to cause a processor of a mobile device to receive, at a lock screen listener module of the mobile device, a notification from a receiver module, indicating that media information has been received from a communications network, and in response to receiving the notification, instruct, by the lock screen listener module, the lock screen display module to display the media information above a lock screen on a display of the mobile device.

In some embodiments, the non-transitory computer readable medium also includes executable instructions operable to cause the processor to monitor a MMS stack to determine whether the media information has been received from the communications network.

In some embodiments, the non-transitory computer readable medium also includes executable instructions operable to cause the processor to provide interactive tools for editing the media information displayed above the lock screen.

### DESCRIPTION OF DRAWINGS

Various objects, features, and advantages of the disclosed subject matter can be more fully appreciated with reference to the following detailed description of the disclosed subject matter when considered in connection with the following drawings, in which like reference numerals identify like elements. The accompanying figures are schematic and are not intended to be drawn to scale. For purposes of clarity, not every component is labeled in every figure. Nor is every component of each embodiment of the disclosed subject matter shown where illustration is not necessary to allow those of ordinary skill in the art to understand the disclosed subject matter.

FIG. 1 illustrates a diagram of a networked communication arrangement in accordance with some embodiments.

FIG. 2 illustrates a mobile device in accordance with some embodiments.

FIG. 3 illustrates receiving an image using a media sharing module from another mobile device that runs a media sharing module in accordance with some embodiments.

FIG. 4 illustrates receiving an image using a media sharing module from another mobile device that runs a generic messaging system in accordance with some embodiments.

FIG. 5 illustrates receiving an image using a media sharing module from another mobile device that runs a media sharing module and sends the image to multiple users in accordance with some embodiments.

FIG. 6 illustrates interacting with received media information in accordance with some embodiments.

FIG. 7 illustrates interacting with received media information when other media information or messages are awaiting the user in accordance with some embodiments.

FIG. 8 illustrates the screens seen by a user when the user chooses to respond to an incoming media notification in accordance with some embodiments.

FIG. 9 shows the feedback that a sender of media information can get once the recipient has reacted to the sent image in some embodiments.

FIG. 10 shows the feedback that a sender of an SMS message can get once the recipient has reacted to the sent image in accordance with some embodiments.

FIG. 11 shows the appearance of screens when a user chooses to manipulate privacy controls in accordance with some embodiments.

FIG. 12 shows the ability of a user to set an incoming image as their wallpaper in some embodiments.

FIG. 13 shows how a user views unread messages when the user enters the media sharing application in accordance with some embodiments.

FIG. 14 shows how a user scrolls through different images that have been exchanged in a conversation with a friend(s) in accordance with some embodiments.

FIG. 15 shows how the media sharing application layer interacts with the operating system and other software in accordance with some embodiments.

FIG. 16 shows an interaction of the media sharing module and other software modules in a mobile device in accordance with some embodiments.

FIG. 17 shows a process performed by a wallpaper manager module for selecting and drawing new wallpapers in accordance with some embodiments.

FIG. 18 shows a process performed by a lock screen listener module for receiving a message with media information in accordance with some embodiments.

FIG. 19 shows a process performed by a lock screen interaction module for handling a user's interaction with a media notification in accordance with some embodiments. The

FIG. 20 shows a set of data structures used in the media sharing module in accordance with some embodiments.

FIG. 21 shows an experience of wallpaper messaging in accordance with some embodiments.

FIG. 22 shows a process, performed by the media sharing module, for messaging and drawing new wallpapers in accordance with some embodiments.

FIG. 23 shows a flow diagram of a process 2300 performed by a mobile device in accordance with some embodiments.

### DESCRIPTION OF EXAMPLE EMBODIMENTS

In some embodiments, the invention provides an apparatus for providing media information received from a communications network. The apparatus includes non-transitory memory storing computer readable instructions. The apparatus also includes one or more interfaces for receiving the media information from the communications network. The apparatus additionally includes a processor in communication with the one or more interfaces and the memory. The computer readable instructions are configured to cause the processor to determine whether the apparatus has received media information from the communication network, and in response to determining that the apparatus has received the media information, instruct, by the media sharing module, a lock screen display module to display the media information over a lock screen.

In some embodiments, a lock screen can include a user interface element used by various operating systems. A lock screen can regulate immediate access to a device by requiring that the user perform a certain action in order to receive access, such as entering a password, using a certain button combination, or performing a certain gesture using a device's touchscreen.

In some embodiments, determining whether the apparatus has received media information from the communication network includes monitoring, by a media sharing module, a MMS stack. In some embodiments, determining whether the apparatus has received media information from the communications network includes receiving media information through an application. For example, one of software applications running on the apparatus can receive media information over the communications network. In this case, the apparatus can receive a notification from the one of the software applications, indicating that the apparatus has received media information from the communications network.

In some embodiments, displaying the media information over a lock screen may not require user input. In some embodiments, displaying the media information over a lock screen may include displaying full content including, for example, accompanying text, a full image, etc. In some embodiments, a user may interact with the content on the lock screen. For example, a user may react to an image (including “loving” the image, and/or drawing on it in real time). In some embodiments, the media information may include third-party content, e.g., content from social media platforms such as Instagram (via an API), or flight information from an airline, etc. In some embodiments, a user may control privacy settings. For example, the Instagram application running on a mobile device can receive a photo, and notify the mobile device that media information is available for display above the lock screen, which is subsequently displayed on the mobile device. In some embodiments, a user may remove a notification on top of the lock screen by a “natural” way, e.g., by sweeping or peeling an image.

In some embodiments, the lock screen displayed by the lock screen display module is shown only in response to receiving the media information, and the lock screen is not a permanent or full-time secondary lock screen above the native lock screen.

In some embodiments, the invention provides an apparatus for providing a wallpaper. The apparatus includes a display, non-transitory memory storing computer readable instructions, one or more interfaces for receiving media information from a communications network; and a processor in communication with the one or more interfaces and the memory. The computer readable instructions are configured to cause the processor to receive, by a media sharing module, a user defined theme for the wallpaper to be displayed on the display of the apparatus, query, by the media sharing module, an image database for one or more images associated with the user defined theme, and cause, by the media sharing module, a wallpaper display module to display the one or more images as the wallpaper on the display.

In some embodiments, the media sharing module may change the wallpaper in response to incoming media information from the communications network.

### Detailed Description

Existing mechanisms for sharing media information have limitations. For example, incoming media information is queued on the mobile device with other un-read contents (e.g., emails, missed phone calls, application updates) until the user of the mobile device finds time to find and go through them. This may require, for example, navigating through multiple levels of user interfaces, which may be time consuming and degrade the user experience. Furthermore, the existing mechanisms may not encourage enough appreciation of the incoming media information—while the existing mechanisms may alert users that the media information has not been read, the existing mechanisms may not sufficiently encourage users to read the media information.

Some existing notification mechanisms provide notifications on a lock screen. This may provide the advantage of reducing the number of interactions with the user interface. However, the inventors of the present application realized that these mechanisms are very different and/or have several drawbacks. For example, alarm clock notifications and incoming phone calls do take over the lock screen, however, this is not for the purpose of displaying incoming content (much less interactive content) and is instead the standard mode by which users can respond to basic phone functions.

Also, some message notification mechanisms that purport to display images above a lock screen have their own independent lock screens, which may severely limit user experience, for example because the secondary lock screen is constantly overlaid to a native lock screen. For example, when a mobile device receives an image, the user has to first unlock the lock screen associated with the notification mechanism to view the image. Then, if the user wants to access other applications managed by an operating system of the mobile device, the user has to unlock a second lock screen that is native to the operating system. Even when the mobile device does not receive any image, if the user wants to access applications managed by an operating system of the mobile device, the user has to unlock two lock screens: a first one associated with the notification mechanism and a second one associated with the operating system of the mobile device. This can severely limit the user experience. In addition, such mechanisms may show notifications regardless of whether there is new media information waiting for the user. For example, such mechanisms may show generic marketing and news content on the secondary lock screen, regardless of whether that content is specifically intended for the user. In addition, existing systems may only allow the user to passively read the news or advertisement information shown on the secondary lock screen, without being able to interact with it.

The media sharing mechanism disclosed herein may obviate such issues because the user interface (UI)/user experience (UX) elements allow users to interact with incoming media information with only limited steps. In addition, the inventors of the present application realized that removing the second lock screen may require the ability to have an image show up above the lock screen on an on-demand basis, and existing notification mechanisms may not have that capability. For example, existing systems do not provide a notification mechanism that shows media information (e.g., image or text, such as offers or deals from retailers) above the lock screen only when there is new media information waiting for the user. As used herein, displaying media “above” the lock screen means that media may be overlaid on the lock screen, for example using transparency, framing, or other visual effect that partly reveals the existing lock screen underneath. In the alternative, media may be displayed above the lock screen by completely blocking the lock screen. In that case, the user may reveal the lock screen by dismissing the media or swiping it to the side.

The embodiments disclosed herein can provide a user-friendly media sharing mechanism for sharing media information amongst multiple mobile devices over a communication network. In particular, the disclosed media sharing mechanism can enable a mobile device to display the media information above the lock-screen native to the operating system (e.g., provided as part of the operating system) on an on-demand basis. For example, when a user receives media information at a mobile device, the mobile device can display the media information above the lock-screen native to the operating system. The mobile device can include advanced UI/UX elements that allow users to interact with incoming media information with only limited steps. In some embodiments, the disclosed media sharing mechanism can enable a mobile device to display the media information above a third-party lock-screen that is not native to the operating system. As used herein, “lock screen” includes any user interface that may be active when a device is not being actively used, even if the user interface does not “lock” the device against unauthorized use, and even though it does not use a traditional “screen” (e.g., it could be a user interface for a head-mounted display).

The disclosed media sharing mechanism allows a mobile device to display incoming media information as a full-screen (or a non-full screen) notification that is temporarily overlaid on the lock screen as the information arrives on the mobile device. The notification can appear above the lock screen when there is media information waiting for a user. This allows users to interact with the media information above the lock screen directly, instead of separately initiating a media application to view the media information. In some embodiments, the disclosed media sharing mechanism can allow media messages (e.g., messages including media information) to be prioritized over other contents or messages. As used herein, the term “message” includes mobile messages (e.g., SMS), instant messages, online chat messages, social media updates, application contents, commercial offers, promotions and advertisements, and any other types of message.

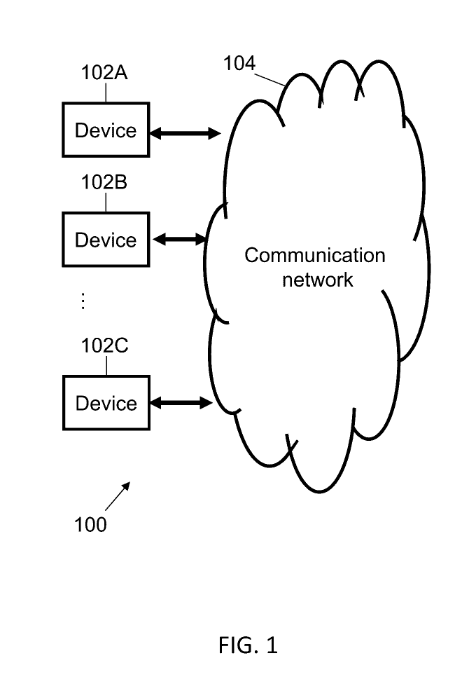

FIG. 1 illustrates a diagram of a networked communication arrangement in accordance with some embodiments. The networked communication arrangement 100 can include at least one mobile device 102 (e.g., computing device 102A, 102B, 102C), and a communication network 104.

The communication network 104 can include a network or combination of networks that can accommodate data communication. For example, the communication network can include a local area network (LAN), a virtual private network (VPN) coupled to the LAN, a private cellular network, a private telephone network, a private computer network, a private packet switching network, a private line switching network, a private wide area network (WAN), a corporate network, a public cellular network, a public telephone network, a public computer network, a public packet switching network, a public line switching network, a public wide area network (WAN), or any other types of networks implementing one of a variety of communication protocols, including Global System for Mobile communication (GSM), Universal Mobile Telecommunications System (UMTS), Long Term Evolution (LTE), and/or IEEE 802.11. Such networks may be implemented with any number of hardware and software components, transmission media and network protocols. FIG. 1 shows the network 104 as a single network; however, the network 104 can include multiple interconnected networks listed above.

The mobile device 102 can include a non-transitory computer readable medium that includes executable instructions operable to cause the mobile device 102 to run the media sharing application. The media sharing application can allow the computing devices 106 to communicate over the communication network 104. The mobile device 102 can be configured with one or more processors that process instructions and run instructions that may be stored in a non-transitory computer readable medium. The processor also communicates with the non-transitory computer readable medium and interfaces to communicate with other devices. The processor can be any applicable processor such as a system-on-a-chip that combines a central processing unit (CPU), an application processor, and flash memory. A mobile device 102 can send data to, and receive data from, other mobile devices 102 over the communication network 104. In some embodiment, a mobile device 102 can broadcast data to, and receive data from, other mobile devices 102 over the communication network 104.

In some embodiments, the mobile device 102 can be a smart phone offering advanced capabilities such as word processing, web browsing, gaming, e-book capabilities, an operating system, and a full keyboard. In other embodiments, the mobile device 102 may be a wearable device, such as a smart watch, wristband, virtual-reality headset, or head-mounted display. In the embodiments discussed below, the word “phone” may be used as a shorthand for such a mobile device and any other mobile device to which the invention may be applied, even where the mobile device may not conventionally be considered a traditional mobile phone. The mobile device 102 may run an operating system such as Symbian OS, Apple iOS, Blackberry OS, Windows Phone, Linux, Palm WebOS, and Android. The screen may be a touch screen that can be used to input data to the mobile device 102 and the screen can be used instead of the full keyboard. The mobile device 102 may have the capability to run applications or communicate with applications that are provided by servers in the communication network. The mobile device 102 can receive updates and other information from these applications on the network. The mobile device 102 can also provide a variety of user interfaces such as a keyboard, a touch screen, a trackball, a touch pad, and/or a mouse. The mobile device 102 may also include speakers and a display device in some embodiments.

In some embodiments, a mobile device 102 can include a media sharing module. The media sharing module can allow the mobile device 102 to share media information with other mobile devices over the communication network system 104. The media information can include an image, a picture, a photograph, a video, text information, application contents, commercial offers, promotions and advertisements, and/or any visual information that may be provided to a user, e.g., viewed on a screen of a mobile device 102. For example, an app-based radio station (e.g., Spotify or Pandora) may push controls for the music above the lock screen instead of showing them in the notification tray, or airline applications may push boarding passes or flight information above the lock screen. As another example, payment applications (e.g., Square) may show payment information.

For the purpose of discussion, the foregoing figures illustrate how the disclosed subject matters are embodied in the media sharing application. However, the disclosed subject matters can be implemented as standalone software applications that are independent of the media sharing application, or it can be integrated into the operating system, system library, or other system software.

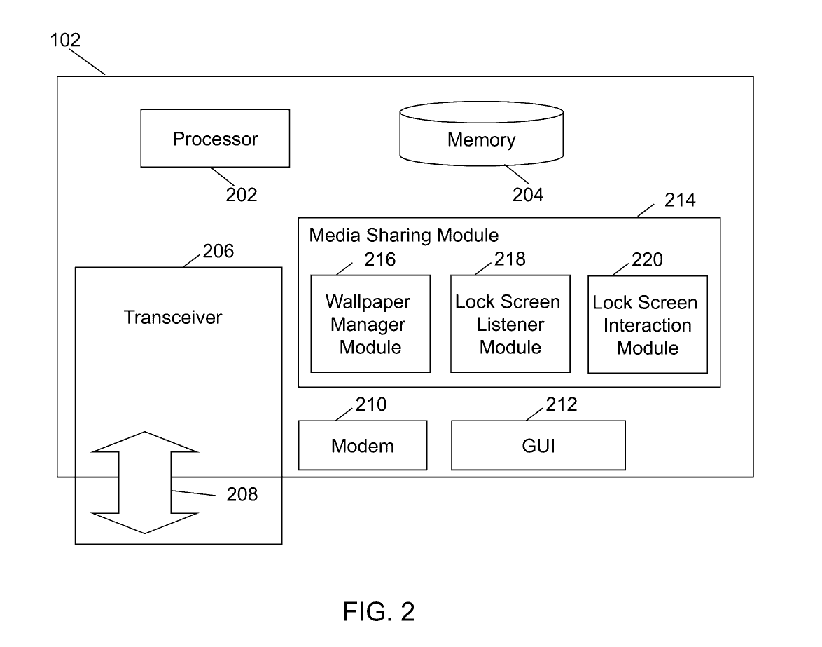

FIG. 2 illustrates a mobile device in accordance with some embodiments. The mobile device 102 can include a processor 202, a memory 204, a transceiver 206 including an interface 208, a modem 210, a Graphical User Interface (GUI) 212, and a media sharing module 214.

The processor 202 can be configured to process instructions and run software that may be stored in memory 204. The processor 202 can communicate with the memory and interfaces to communicate with other devices. The processor 202 can be any applicable processor such as a system-on-a-chip that combines a CPU, an application processor, and flash memory.

The memory 204 can include memory such as a computer readable medium, flash memory, a magnetic disk drive, an optical drive, a programmable read-only memory (PROM), and/or a read-only memory (ROM).

The transceiver 206 can include a transmitter and a receiver. The transmitter and the receiver can be integrated into a single chip or can be embodied in separate chips. The transceiver 206 can also include an interface 208 that provides an input and/or output mechanism to communicate with other network devices. The interface 208 can measure the wireless signal strengths of wireless interfaces such as base stations and access points. The interface 208 can be implemented in hardware to send and receive signals in a variety of mediums, such as optical, copper, and wireless, and in a number of different protocols some of which may be non-transient.

The modem 210 is configured to implement modulation and framing of signals according to one or more communication standards. The communication standards include WLAN related standards such as 802.11 and its addenda, and the cellular standards defined under 3GPP.

The GUI 212 can provide communication with an input and/or output mechanism to communicate with mobile device users. Mobile device users can use input/output devices to provide/receive data to/from the mobile device 102 over the GUI 212. Input/output devices can include a keyboard, a screen, a touch screen, a monitor, and a mouse. The GUI 212 can operate under a number of different protocols, and the GUI 212 can be implemented in hardware to send and receive signals in a variety of mediums, such as optical, copper, and wireless.

The media sharing module 214 can be configured to run a media sharing application (MSA). The media sharing module 214 can include a wallpaper manager module 216, a lock screen listener module 218, and a lock screen interaction module 220. In some cases, the media sharing module 214 can be referred to as a media sharing application. As discussed above, the media sharing module can also be integrated into the operating system, system library, or other system software.

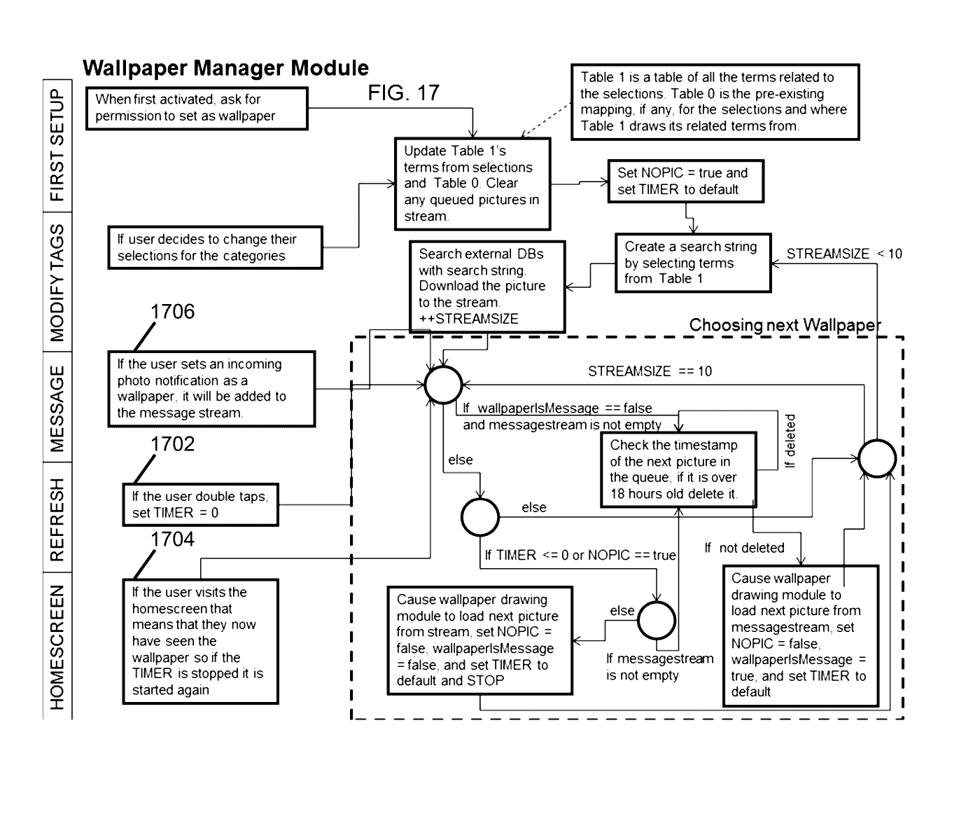

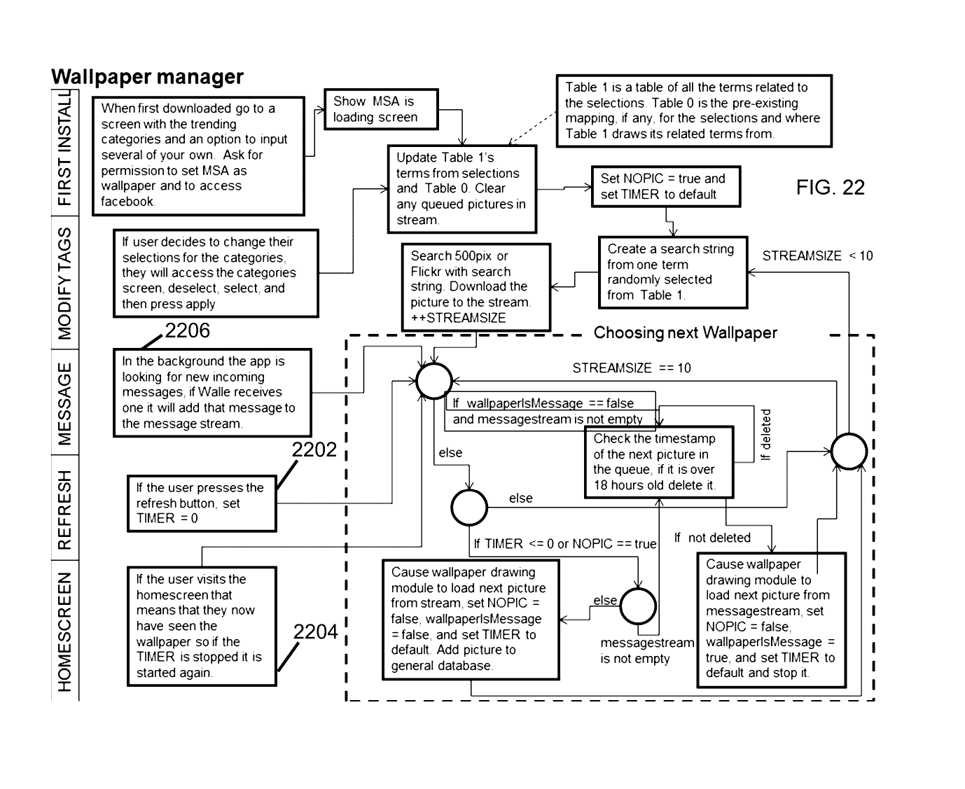

The wallpaper manager module 216 can be configured to receive changes in wallpaper preferences, receive incoming media messages being set as wallpapers, and recognize any gesture controls, such as double taps. The wallpaper manager module 216 can cause a wallpaper drawing and interaction system to draw new wallpapers, manipulate wallpapers to support movement of media information, such as, for example, panning. FIGS. 17 and 22, discussed below, shows exemplary embodiments of a process performed by a wallpaper manager module for selecting and drawing new wallpapers in accordance with some embodiments. As will be explained later in reference to FIG. 17, the wallpaper manager module 216 is different from existing wallpaper mechanisms because the wallpaper manager module 216 may be configured to draw new wallpapers automatically based on a user request (e.g., a user interacting with the wallpapers) or through incoming media content from another device over a communications network.

The lock screen listener module 218 can monitor the Multimedia Messaging Service (MMS) stack for incoming media messages, monitor incoming media information, and also monitor other messages beyond media information. In some embodiments, protocols other than MMS may be used, including proprietary protocols.

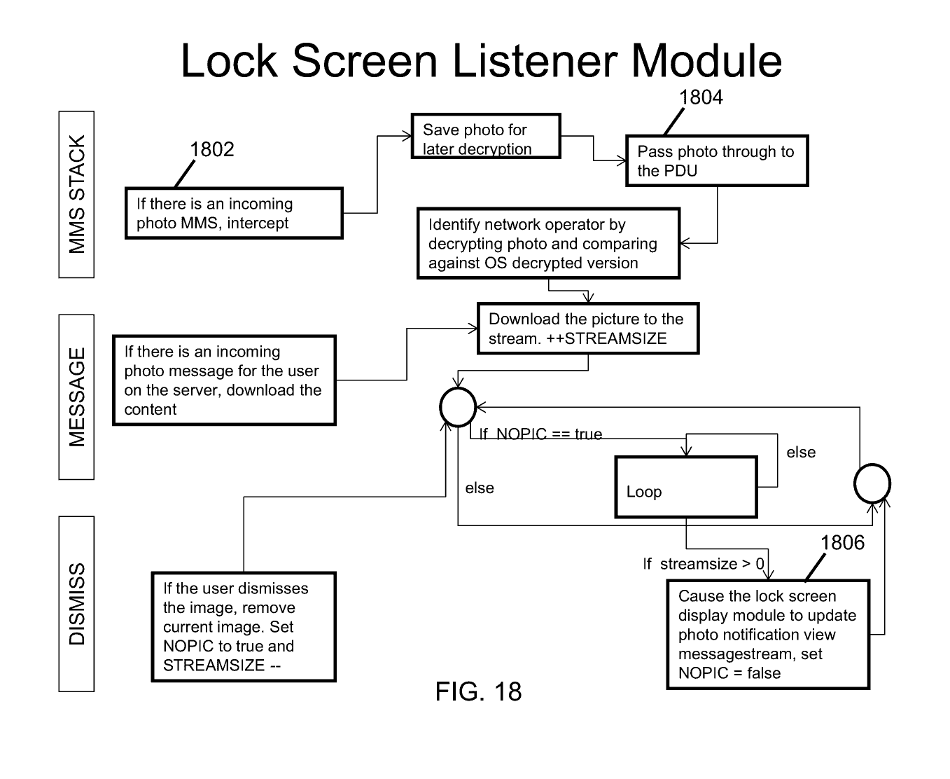

The lock screen listener module 218 can cause a lock screen display to display media notifications that span the entire screen. FIG. 18, discussed below, shows a process performed by a lock screen listener module for receiving a message with media information in accordance with some embodiments. The lock screen listener module 218 can interact with the lock screen interaction module by bringing up the reaction controls when new incoming media information is presented on the lock screen. The lock screen listener module 218 is different from existing lock screen mechanisms because existing lock screen mechanisms do not allow media information to appear above the lock screen on an on-demand basis.

The lock screen interaction module 220 can receive a user's input and cause the lock screen display to respond to the user's input. The lock screen interaction module 220 can recognize user manipulations of media information, such as images, and provide a mechanism for responding to incoming media information, such as replies or likes. The mechanism for responding to incoming media information may allow users to interact with controls, purchase services and/or products associated with an application that sent the media information, or make payments for services and/or products associated with an application that sent the media information.

In some embodiments, the lock screen interaction module 220 can allow users to annotate media information in real time. Subsequently, the lock screen interaction module 220 can cause the lock screen display to respond to the user's input. For example, the lock screen interaction module 220 can cause the lock screen display to change display formats, such as zoom, split screens etc.

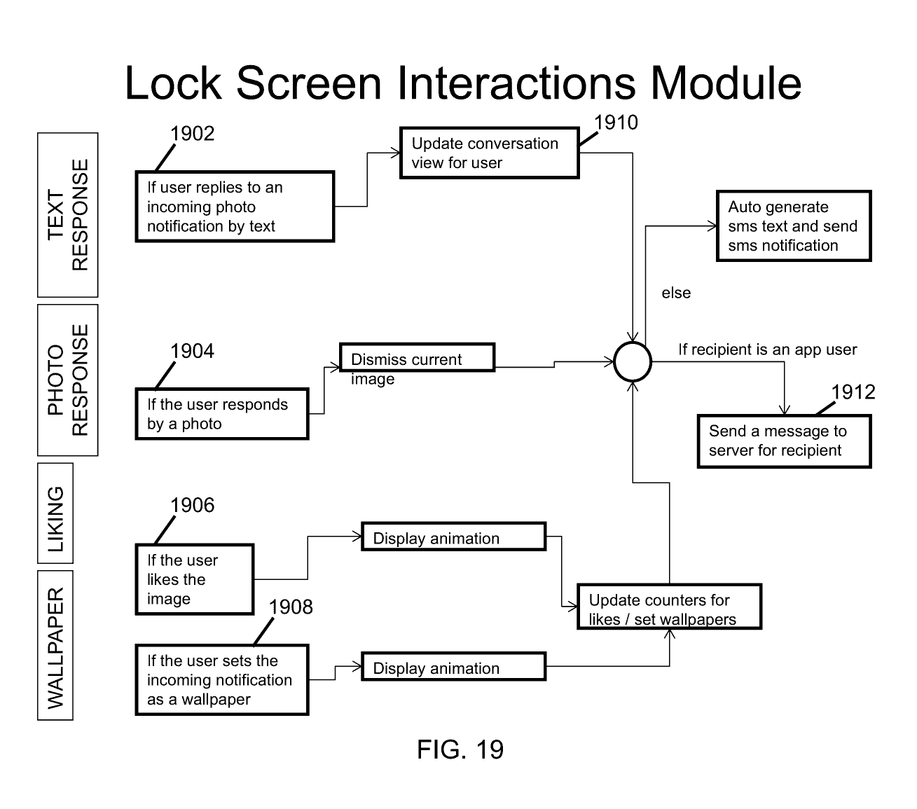

FIG. 19, discussed below, shows a process performed by a lock screen interaction module for handling a user's interaction with a media notification in accordance with some embodiments. The lock screen interaction module 220 can interact with the wallpaper manager module by providing media information that the user would like to set as a wallpaper. As will be explained later in reference to FIG. 19, the lock screen interaction module may provide the user with different tools by which to react to the incoming media information. The lock screen interaction module can receive input from the user and communicate that input with the lock screen display module. Once the user is satisfied with modifications to the media information displayed above the lock screen, the lock screen interaction module can communicate with the backend messaging system to send a response to the sender. The lock screen interaction module 220 can enable the user to draw additional information over the incoming media information, add a sticker or an emoticon over the media information, apply filters or effects to the media information, add text information to the media information, and/or forward the media information to another device. The lock screen interaction module 220 can also allow users to react to the media information displayed above the lock screen and send a response to the sender of the media information (e.g. by sending a text message or a photo or placing a sticker over the incoming photo).

In some embodiments, the media sharing module 214 can be configured to communicate with another media sharing module on another mobile device. The media sharing module 214 can use a proprietary message communication protocol to communicate with other media sharing modules. In other embodiments, the media sharing module 214 can be configured to communicate with a generic messaging system, such as a short message service (SMS).

The media sharing module 214 and its sub-modules can be implemented in software using memory 304 such as a non-transitory computer readable medium, a programmable read only memory (PROM), or flash memory. The software can run on a processor 302 that executes instructions or computer code. The media sharing module 214 may also be implemented in hardware using an application specific integrated circuit (ASIC), programmable logic array (PLA), or any other integrated circuit.

The communication between modules may be performed using known communication mechanisms, such as method calls and function calls. For example, when the lock screen listener module receives a new message, the module can perform a method call to call a method within the lock screen interaction module to display the new message.

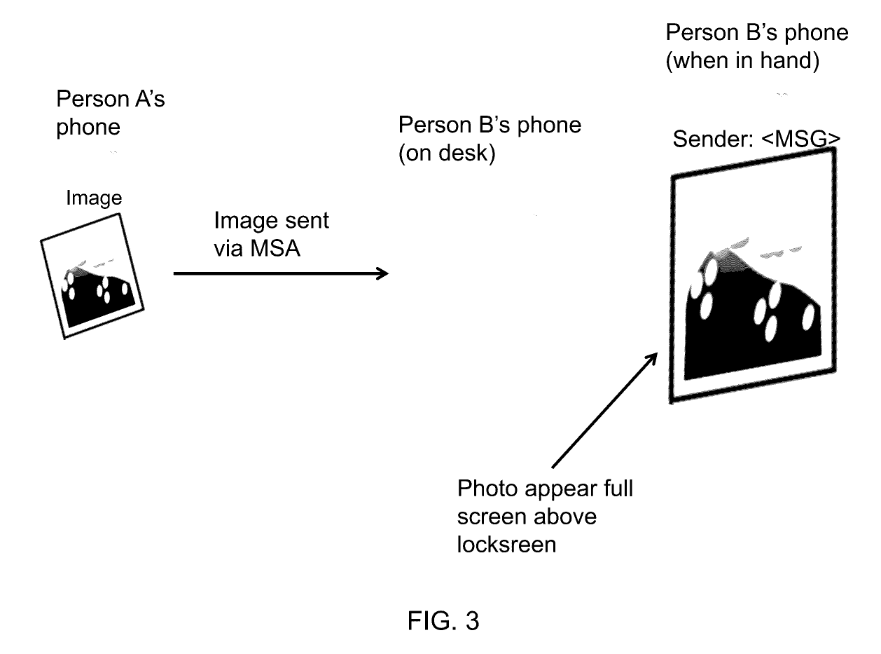

FIG. 3 illustrates receiving an image using a media sharing module from another mobile device that runs a media sharing module in accordance with some embodiments. Person A's mobile device (e.g., phone) and Person B's mobile device (e.g., phone) are configured to communicate with each other using a media sharing application. Person A captures an image using his/her phone and then sends it to Person B using the media sharing application. Suppose that Person B's mobile device is in an idle mode (e.g., not being actively used by a user). When Person B's mobile device receives the image, Person B's mobile device enters into an operating mode and displays the image over a lock screen. The image can be displayed as a full-screen or as a partial-screen. Person B's mobile device can also be configured to display, as an overlay to the image, the name of Person A and the message sent by Person A. Subsequently, Person B can pick up the mobile device and interact with the displayed image. When Person B discards the image, Person B's mobile device can display the regular lock screen.

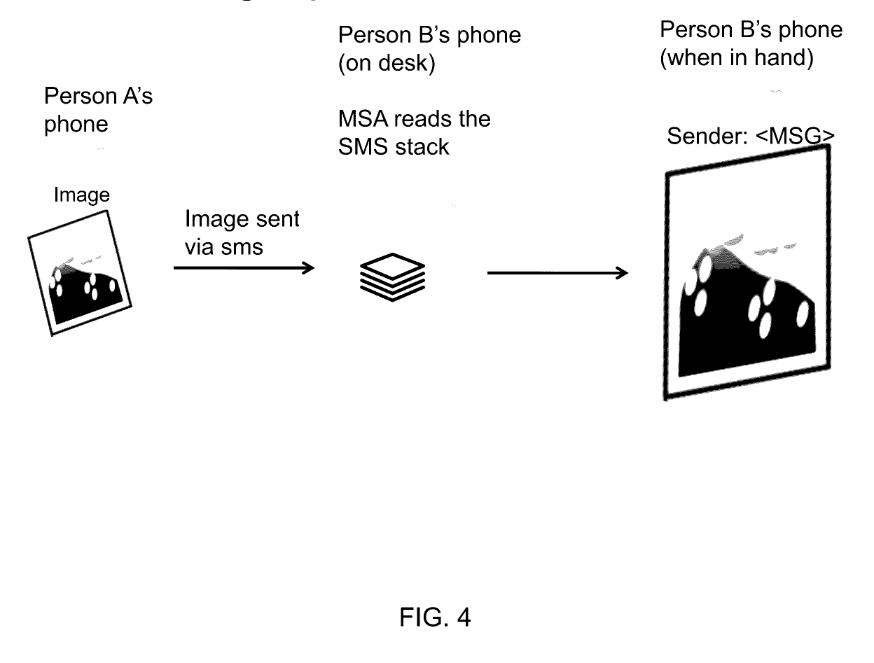

FIG. 4 illustrates receiving an image using a media sharing module from another mobile device that runs a generic messaging system in accordance with some embodiments. Person A's phone is configured to capture an image and send the image to Person B's phone using a generic messaging system, such as SMS. Person B's phone is a second phone running a media sharing application. There is one image of it on a desk and a second after the user picks it up and has it in hand. Person A captures an image using the phone and then sends it to Person B using SMS. The media sharing application running on person B's phone monitors the SMS stack and captures the incoming image. It then lights up showing a full screen version of the image sent by person A with the name of Person A and the message sent by Person A at the top of the image. Once person B discards the image, Person B's phone can display the regular lock screen. In some embodiments, the generic messaging system, using which Person A's phone sends the image, can include an Enhanced Messaging Service (EMS). In some embodiments, Person A's phone may also be able to send via MMS a photo or other media information to a group of friends on their respective mobile devices. Any one of the mobile devices that runs the media sharing application may be able to display the incoming image as an overlay to the regular lock screen.

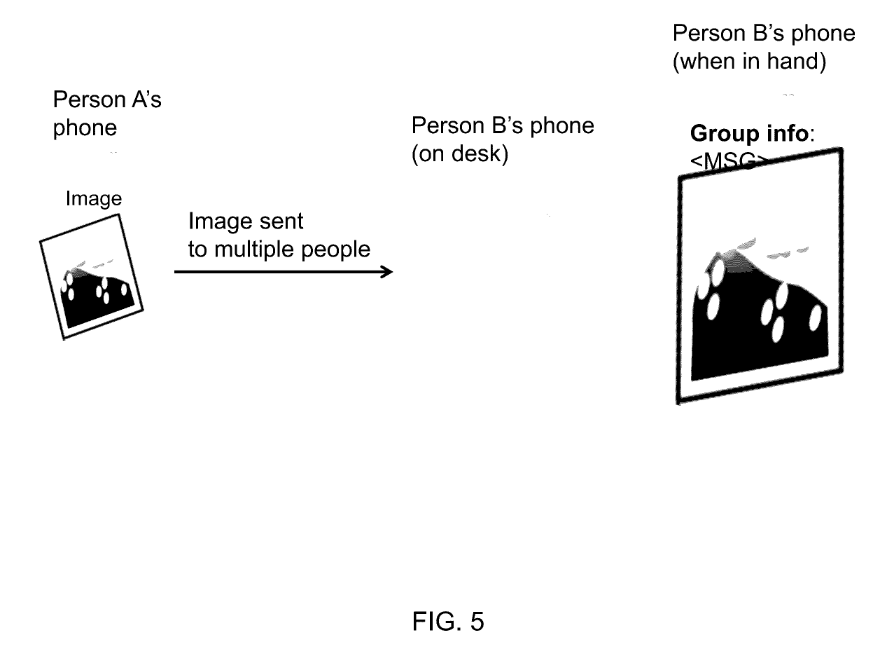

FIG. 5 illustrates receiving an image using a media sharing module from another mobile device that runs a media sharing module and sends the image to multiple users in accordance with some embodiments. Person A's phone is the phone of a person that is running a media sharing application. Person B's phone is a second phone running a media sharing application. There is one image of Person B's phone on a desk and a second after the user picks it up and has it in hand. Person A's phone captures an image and sends it to a group of phones, including Person B's phone, using the media sharing application. In some embodiments, the Person A's phone can broadcast the image to a plurality of phones, including Person B's phone. Once Person B's phone receives the image, Person B's phone then lights up showing a full screen version of the image sent by person A with the name of Person A and the other group members with the message sent by Person A at the top of the image. Once person B discards the image, Person B's phone can display the regular lock screen.

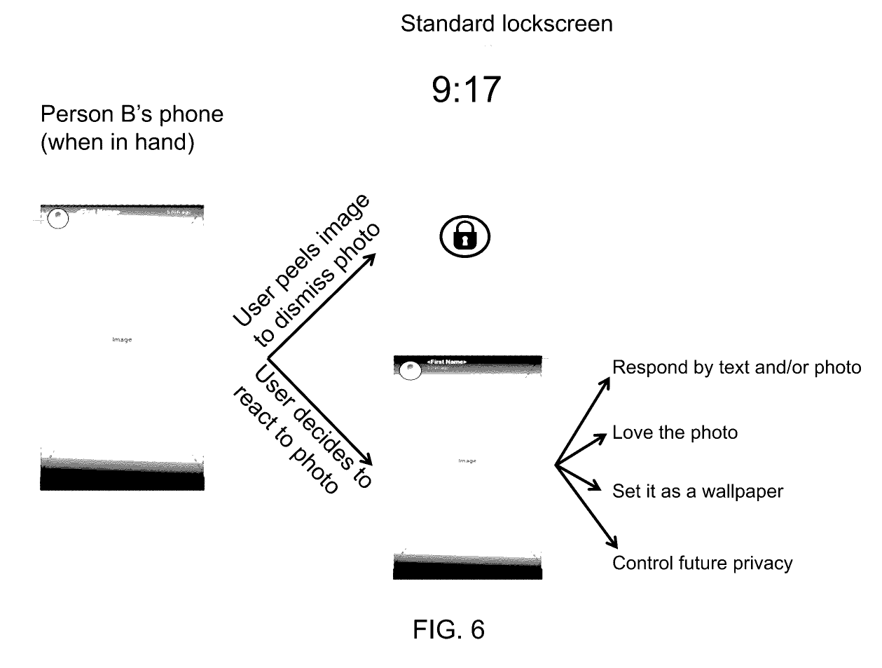

FIG. 6 illustrates interacting with received media information in accordance with some embodiments. Person B's phone is the phone of a person that has received a media notification. The top right image is the standard lock screen. The bottom right image is the received image above the lock screen after the user starts to interact with the image. Person B, having received a media sharing notification, can either dismiss the image through a gesture on the screen, or can click the react button which gives the user a few options on how to react to the image (including by text or image, loving the image, setting it at his wallpaper, choosing to change privacy settings going forward).

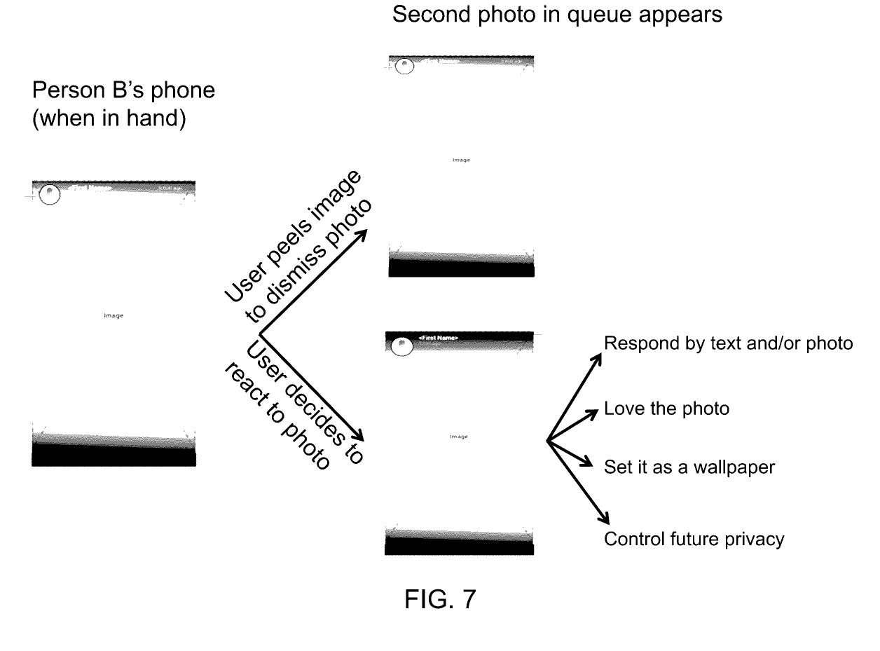

FIG. 7 illustrates interacting with received media information when other media information or messages are awaiting the user in accordance with some embodiments. Person B's phone is the phone of a person that has received more than one media notification and has it in his hands. The top right image is a second media notification. The bottom right image is the received image above the lock screen after the user starts to interact with it. Person B, having received a media sharing notification, can either dismiss the image through a gesture on the screen, in which case he would see the next image in the queue or can click the react button which gives the user a few options on how to react to the image (including by text or image, loving the image, setting is at his wallpaper, choosing to change privacy settings going forward).

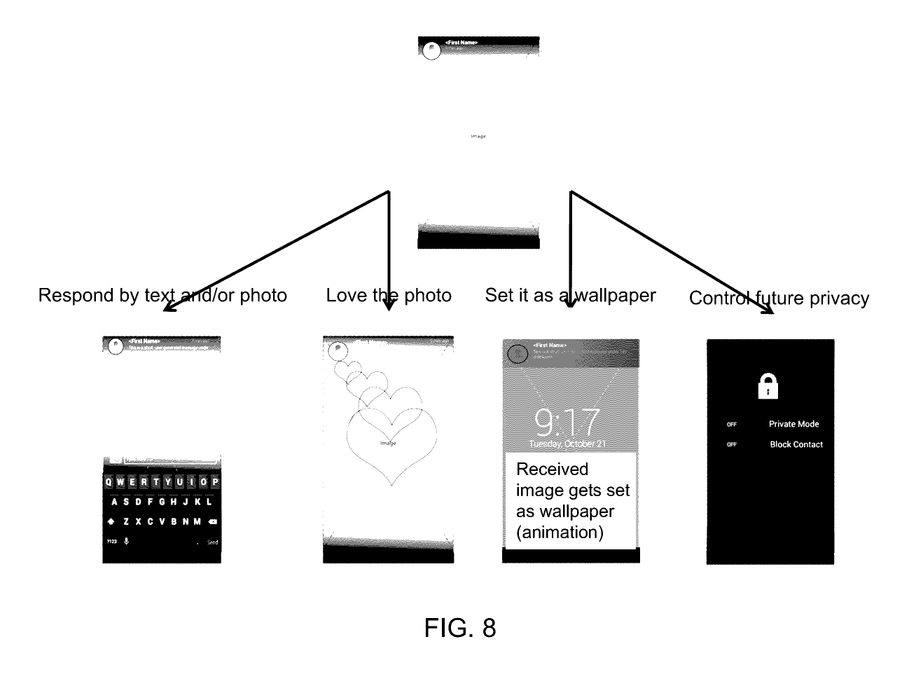

FIG. 8 illustrates the screens seen by a user when the user chooses to respond to an incoming media notification in accordance with some embodiments. The top phone is that of a person that has received one or more media notification. The bottom images, from left to right, illustrate responding by text or image, loving the image, setting it as wallpaper, and controlling privacy settings, respectively. When the mobile device receives a user input (e.g., a selection of a button on the top phone), the mobile device can provide corresponding reactions, as illustrated in images at the bottom.

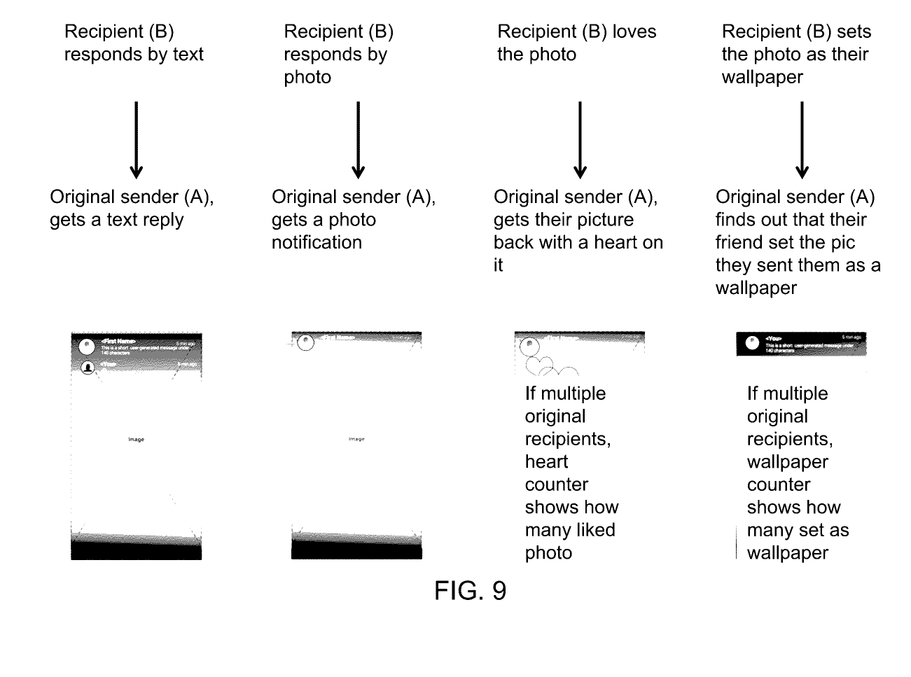

FIG. 9 shows the feedback that a sender of media information can get once the recipient has reacted to the sent image in some embodiments. The images from left to right are what the original sender sees once the recipient of their image has i) responded by text, ii) responded by image, iii) loved the image, iv) set it as wallpaper.

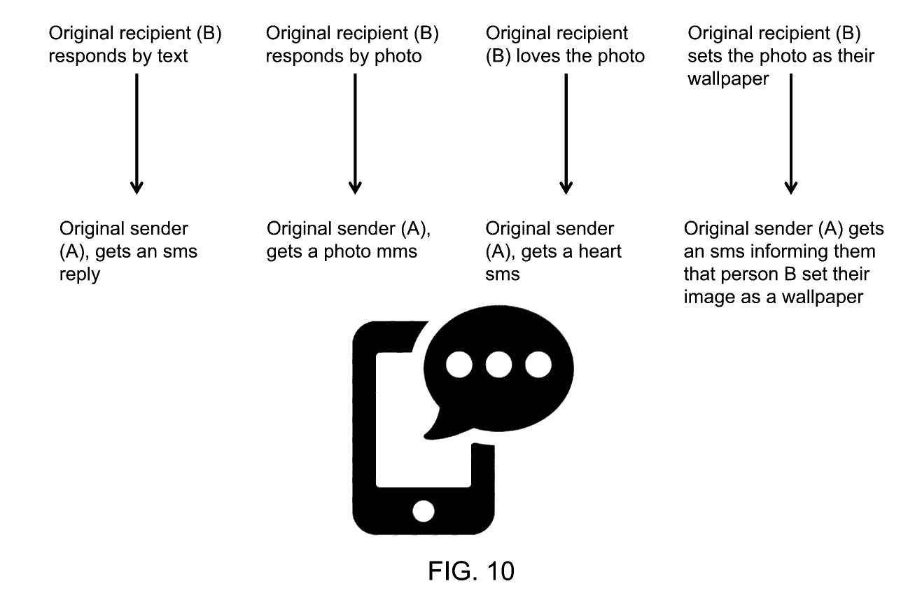

FIG. 10 shows the feedback that a sender of an SMS message can get once the recipient has reacted to the sent image in accordance with some embodiments. The reactions through the media sharing application may be translated into information that can be sent via SMS or other protocols, and may be sent back to the original sender via that format or other protocols.

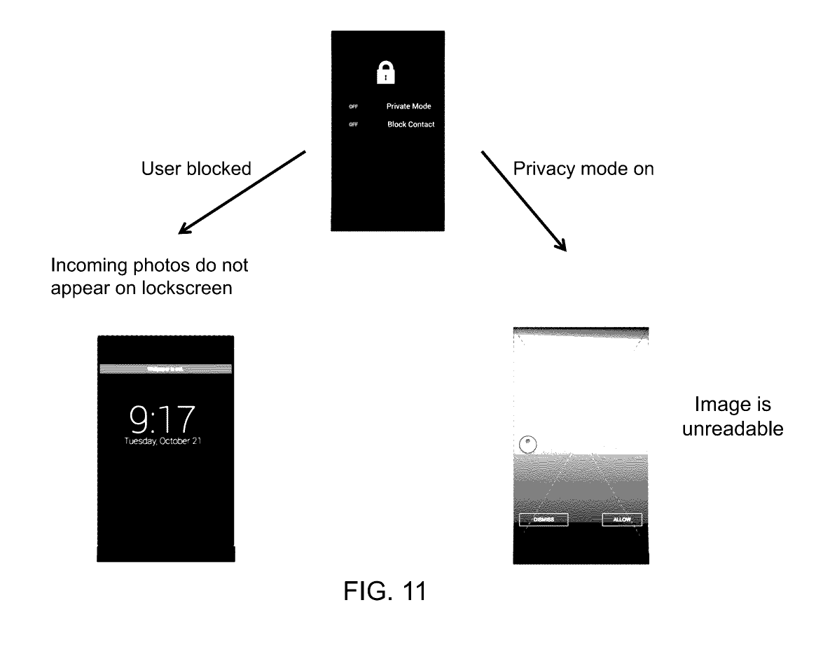

FIG. 11 shows the appearance of screens when a user chooses to manipulate privacy controls in accordance with some embodiments. The top phone is that of a person that is beginning to interact with privacy options. The bottom images, from left to right are, i) the lock screen view after a blocked friend sends a media sharing image, and ii) the lock screen view after privacy controls are turned on and a new media sharing image is received, respectively. If the user decides to block another user, then all images sent by that blocked user will no longer show up on the lock screen. For example, the image blocking is achieved by filtering out images arriving from a specific user ID If the user decides to turn privacy mode on, then all images will be unreadable when they are received by the user. The methods by which an unreadable image can be made readable may include, for example, clicking an overlay that allows the image to be decrypted, as well as other methods that may require additional user interaction, e.g., to perform a personal signature on the image in order to reveal it.

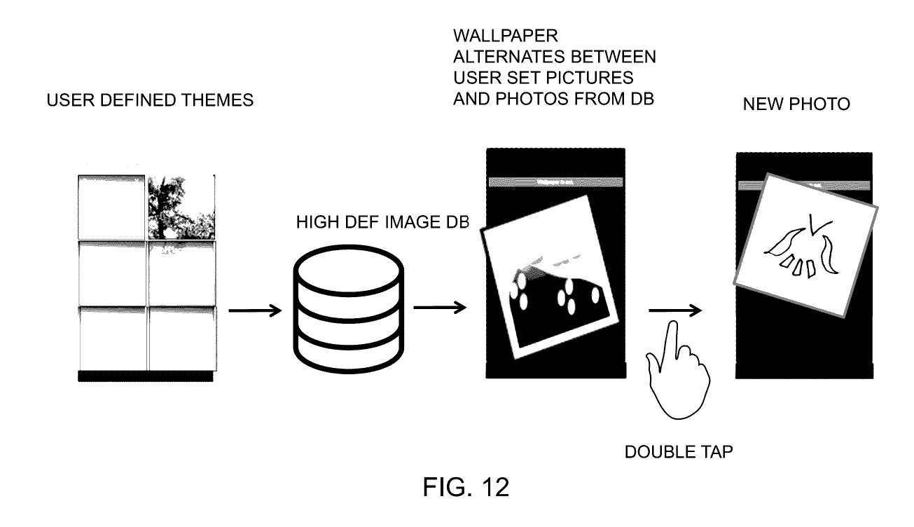

FIG. 12 shows the ability of a user to set an incoming image as their wallpaper in some embodiments. From left to right, the image on the left is the setting screen where a user can select wallpaper themes. The high definition image database are different online repositories from which high definition images are sourced. The next image is that of a phone with a wallpaper that was set by the user selecting an incoming image to become their wallpaper. The rightmost image is that of a phone with a wallpaper that was sourced from the high definition databases. The user can go into the setting screen and change wallpaper themes. The first time that the user decides to react to an incoming media sharing image by setting it as their wallpaper, the wallpaper functionality will be activated. From this point onwards, the wallpaper will change dynamically as well as on demand by user screen gestures. The wallpaper will alternate between images messages that the users sets as wallpapers and those sources from the databases based on the selected themes.

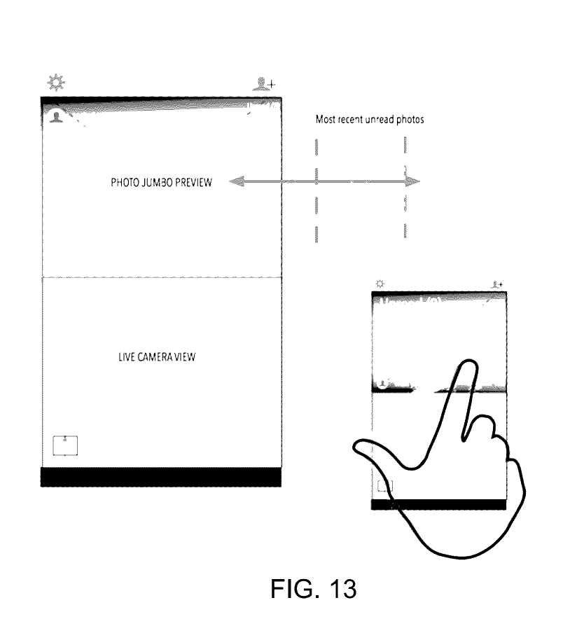

FIG. 13 shows how a user views unread messages when the user enters the media sharing application in accordance with some embodiments. A jumbo preview of an image is shown in the top half of the phone screen so that the user does not miss the images they have not viewed. If a user decides to swipe the image, they will be able to view other unread media notifications.

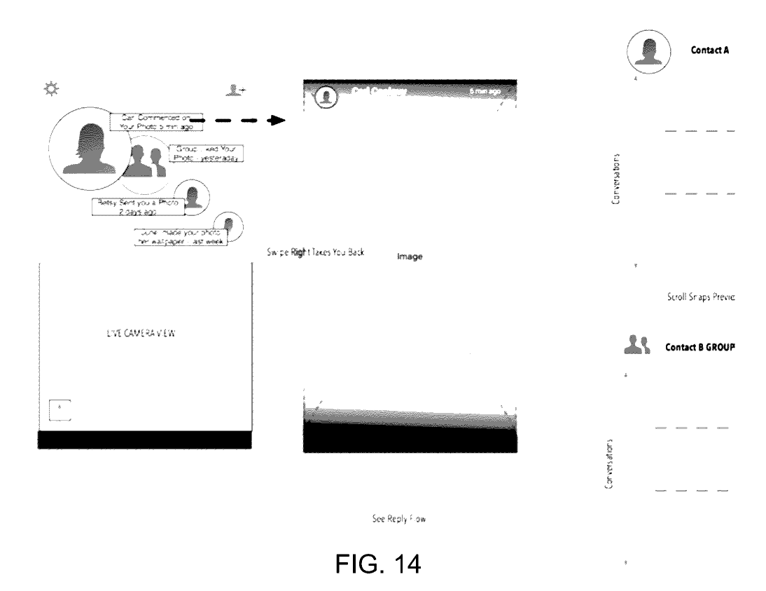

FIG. 14 shows how a user scrolls through different images that have been exchanged in a conversation with a friend(s) in accordance with some embodiments. The left most image shows the conversation header screen which shows all recent conversations (one conversation per user). The next image shows the view after having selected a conversation to go through with a user. By selecting a conversation with a friend, the user is then in the conversation view and can scroll between images exchanged.

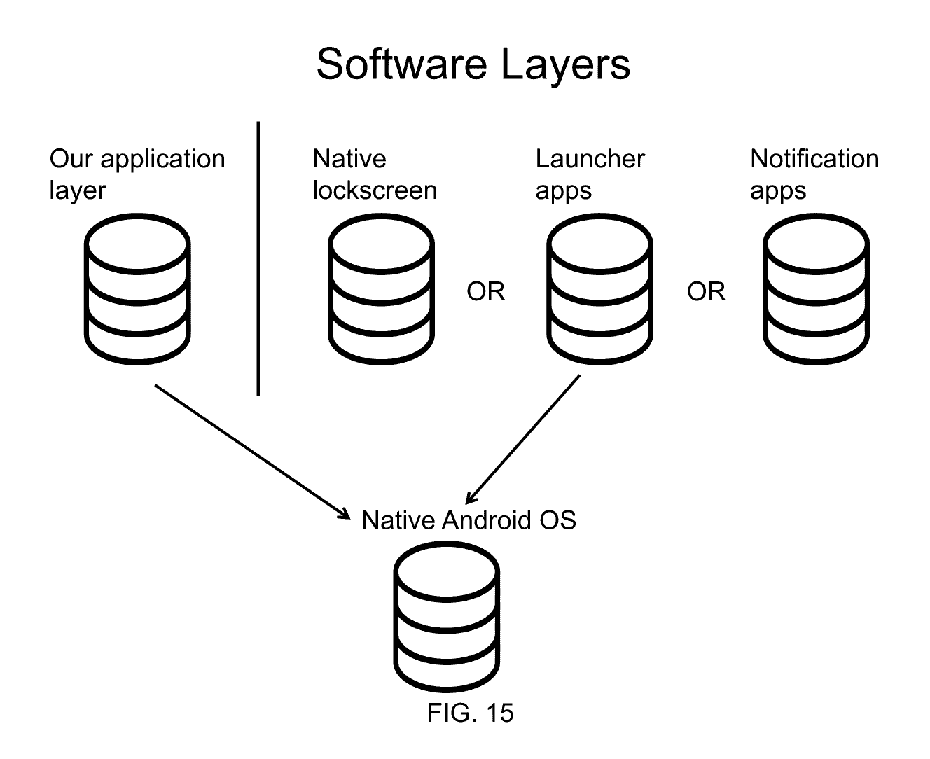

FIG. 15 shows how the media sharing application layer interacts with the operating system and other software in accordance with some embodiments. The media sharing application layer (also referred to as a media sharing module) sits directly over the operating system and interacts with the operating system directly. Any other lock screen type applications would interact with the operating system in parallel to the media sharing layer. The media sharing application layer may interact with the operating system and other software using known methods, for example including method calls and function calls. For example, functions within the media sharing application layer may call operating system methods that provide return values.

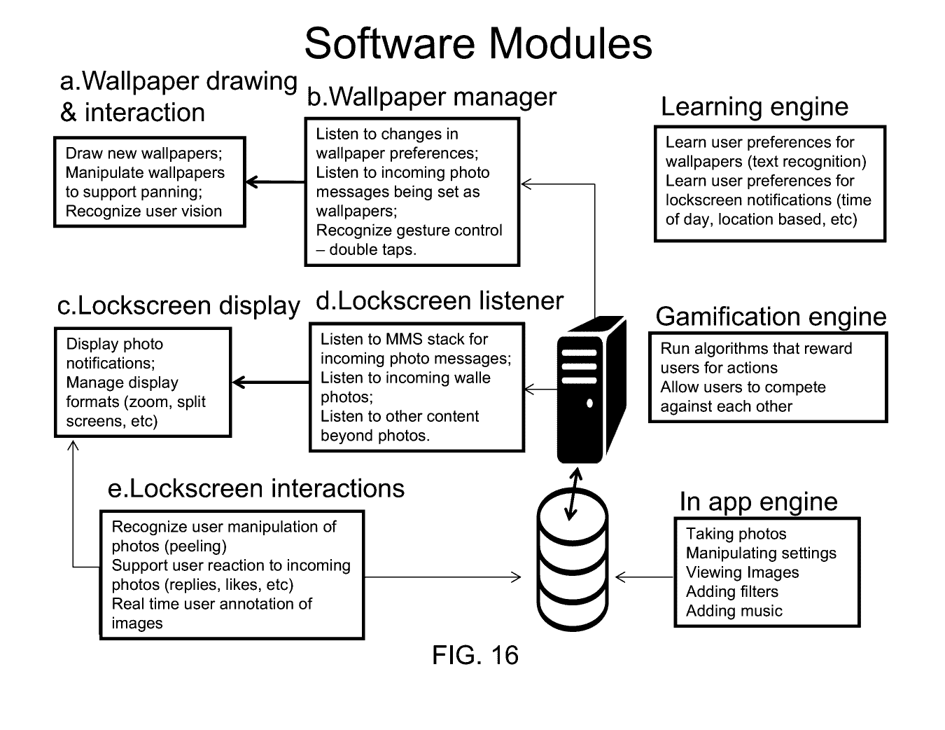

FIG. 16 shows an interaction of the media sharing module and other software modules in a mobile device in accordance with some embodiments. Block a is the wallpaper drawing & interaction module that displays wallpapers. Block b is the wallpaper manager module 216 that decides how the images should change. Block c is lock screen display that displays the incoming images on top of the lock screen. Block d is the lock screen listener module 218 that picks up incoming content. Block e is the lock screen interactions module 220 that allows a user to interact with incoming images when they are on top of the lock screen.

The system illustrated in FIG. 16 allows notifications to appear above the lock screen when there is new media information to be displayed to a user of the mobile device. For example, as explained later in reference to FIG. 18, the lock screen listener module is configured to listen to incoming media information (including those from a messaging backend), intercept the incoming media information, and provide the intercepted media information to the lock screen display module so that the lock screen display module can draw the media information above the lock screen. This allows the lock screen display module to display the media information above the lock screen only when there is new incoming media information. The lock screen display module can be configured to work with the operating system to start an activity that allows it to display content above the lock screen.

In some embodiments, the learning engine learns user preferences over time. For example, the learning engine can learn user preferences by, for example, (1) key words entered that impact the type of wallpapers users like to see, or (2) time and geolocation/location information that affects the type of media information that the user receives on the lock screen and on the wallpaper.

In some embodiments, the gamification engine runs an application that decides how users are rewarded. For example, the gamification engine can decide how a user compares with other users on specific actions such as messaging, photos loved, number of photos that are re-forwarded, etc. The in application (“in app”) engine allows users to go into the application to take and receive images when the images are not displayed on the lock screen. For example, the in application engine allows users to take and receive images by using a camera control screen that allows the user to snap a picture, manipulate the picture using filters and other effects, and select one or more users from a list of users to send the image to (this extends to other media as well).

In some embodiments, the wallpaper manager module 216 receives notifications from the server and sends instructions and the image for redrawing to the wallpaper drawing and interaction module. The lock screen listener module 218 receives notifications from the server and sends instructions and the image for redrawing to the lock screen display module.

FIG. 17 shows a process performed by a wallpaper manager module for selecting and drawing new wallpapers in accordance with some embodiments. This process keeps track of time and exchanges wallpapers when they are due by requesting images from high end image databases. It also responds to users interactions including modifying the wallpapers themes, setting an incoming image message as a wallpaper, use gestures to change the wallpaper, and monitors users viewing of wallpapers to know when they have been viewed. For example, the wallpaper manager can modify the wallpapers themes by capture user preferences.

In some embodiments, the wallpaper manager can set an incoming image message as a wallpaper by listening for user commands through the lock screen interaction module. The wallpaper manager can use gestures to change the wallpaper by listen to user actions such as double taps, etc. The wallpaper manager can monitor users viewing of wallpapers by recognizing that the user has turned on their phone and seen either the lock screen or home screen wallpaper. Using this process, the wallpaper manager module can search external databases, provide the message functionality that allows a user to set an incoming image as their wallpaper, provide the automatic loading of images by causing the wallpaper drawing module to load pictures from the stream, and check that the user visited the home screen and using that information to determine whether the user has seen the image already. As shown in FIGS. 17 and 22, the wallpaper manager module may be configured to draw new wallpapers automatically based on a user request (e.g., a user interacting with the wallpapers as exemplified in blocks 1702/1704/2202/2204). In addition, the wallpaper manager module may be configured to draw new wallpapers from incoming media (e.g., content from another device over a communications network) as exemplified in blocks 1702/2206.

FIG. 18 shows a process performed by a lock screen listener module for receiving a message with media information in accordance with some embodiments. Through this process, the lock screen listener module 218 can manage a queue that supports the buffering of the media information and other messages for their presentation to the user. In some embodiments, the lock screen listener module 218 can intercept a MMS, and cause the lock screen display module to update a media notification above the lock screen. The lock screen listener module is configured to listen to incoming media information, intercept the incoming media information (e.g., block 1802), and provide the intercepted media information to the lock screen display module (e.g., block 1804) so that the lock screen display module can draw the media information above the lock screen. This allows the lock screen display module to display the media information above the lock screen only when there is new incoming media information (e.g., block 1806). The lock screen display module can be configured to work with the operating system to start an activity that allows it to display content above the lock screen.

In some embodiments, when an MMS arrives to the mobile device, the device may read a protocol data unit (PDU) associated with the MMS. In some embodiments, the PDU is a wrapper with different information inside it, including information about the image, as well information about the network that transmitted the MMS. In some embodiments, the lock screen listener module may allow the operating system to parse the PDU into its components.

In some embodiments, the lock screen listener module may directly parse the PDU and compare the result to the output of the operating system when it parses the PDU in order to identify the network provider. This allows the lock screen listener module to identify the network provider even when the decrypted version of the MMS does not include the network provider information.

In some embodiments, in order to intercept the MMS, the lock screen listener module may include a receiver and a content observer that is configured to monitor the MMS stack. The MMS stack can include the MMS after the PDU is parsed and the image is downloaded.

FIG. 19 shows a process performed by a lock screen interactions module for handling a user's interaction with a media notification in accordance with some embodiments. The lock screen interactions module 220 can be configured to enable a user to set incoming image messages as wallpapers, keep track of likes and wallpaper sets on the images that are being shared, and in general, allow a user to respond to an incoming image by text, image, liking or setting as wallpaper above the lock screen. For example, the lock screen interactions module 220 can be configured to receive a user's instruction to respond to the media notification by sending, to the sender of the media information, i) a text (e.g., SMS text), ii) an image, and/or iii) an indication that the user loves or likes the media. Also, the lock screen interactions module 220 can also cause the wallpaper drawing and interaction module to set the received media as a wallpaper. The lock screen interaction module may provide the user with different tools by which to react to the incoming media information. The lock screen interaction module can receive input from the user and communicate that input with the lock screen display module (e.g., blocks 1902/1904/1906/1908). Once the user is satisfied with modifications to the media information displayed above the lock screen (e.g., block 1910), the lock screen interaction module can communicate with the backend messaging system to send a response to the sender (e.g., block 1912). The lock screen interaction module 220 enables the user to draw additional information over the incoming media information, add a sticker or an emoticon over the media information, apply filters or effects to the media information, add text information to the media information, and/or forward the media information to another device.

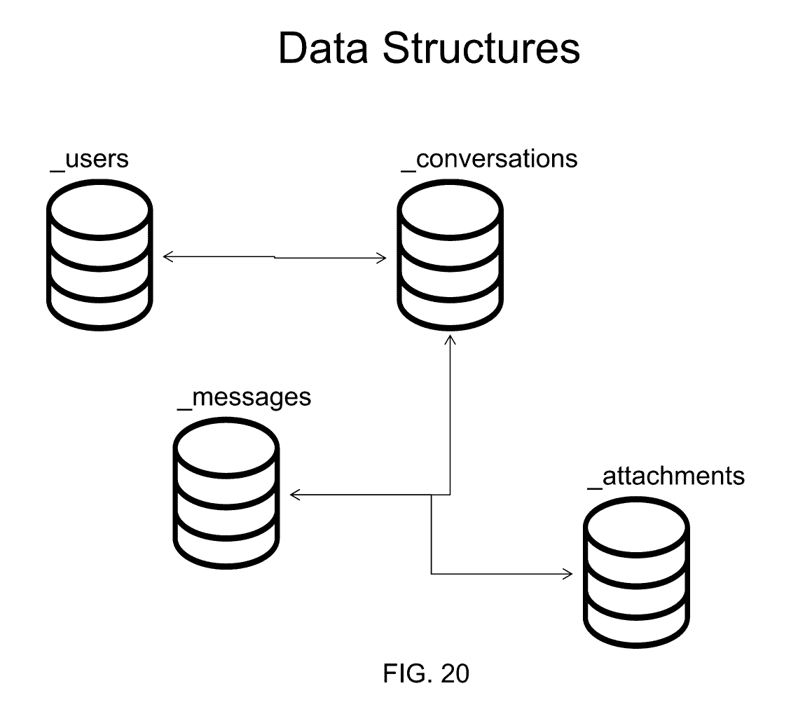

FIG. 20 shows a set of data structures used in the media sharing module in accordance with some embodiments. The set of data structures can include a user table which stores information about users, a conversations table which stores data on messages belonging to a single user, a messages table which has all messages and their content, and an attachments table which handles images associated with messages.

In some embodiments, the media sharing module 214 can be configured to change a wallpaper of another mobile device. As discussed above, a media sharing module 214 can be configured to modify a wallpaper of the mobile device in which the media sharing module 214 resides. In some cases, a first media sharing module, residing in a first mobile device, can cause a second media sharing module, residing in a second mobile device, to change the wallpaper of the second mobile device. For example, the first media sharing module can send an image to a second media sharing module, and cause the second media sharing module to change the wallpaper of the second mobile device. In response, the second media sharing module can change the wallpaper of the second mobile device.

In some embodiments, the first media sharing module can cause the second mobile device to change the wallpaper of the second device by instructing the second mobile device to queue the received image in a wallpaper queue (e.g., a buffer) that maintains all images to be cycled through as a wallpaper. In other embodiments, the first media sharing module can cause the second mobile device to change the wallpaper of the second device by adding the image to a high definition image database, illustrated in FIG. 12.

In some cases, the second media sharing module can change the wallpaper of the lock screen; in other cases, the second media sharing module can change the wallpaper of the home screen; in yet other cases, the second media sharing module can change the wallpaper of both the lock screen and the home screen.

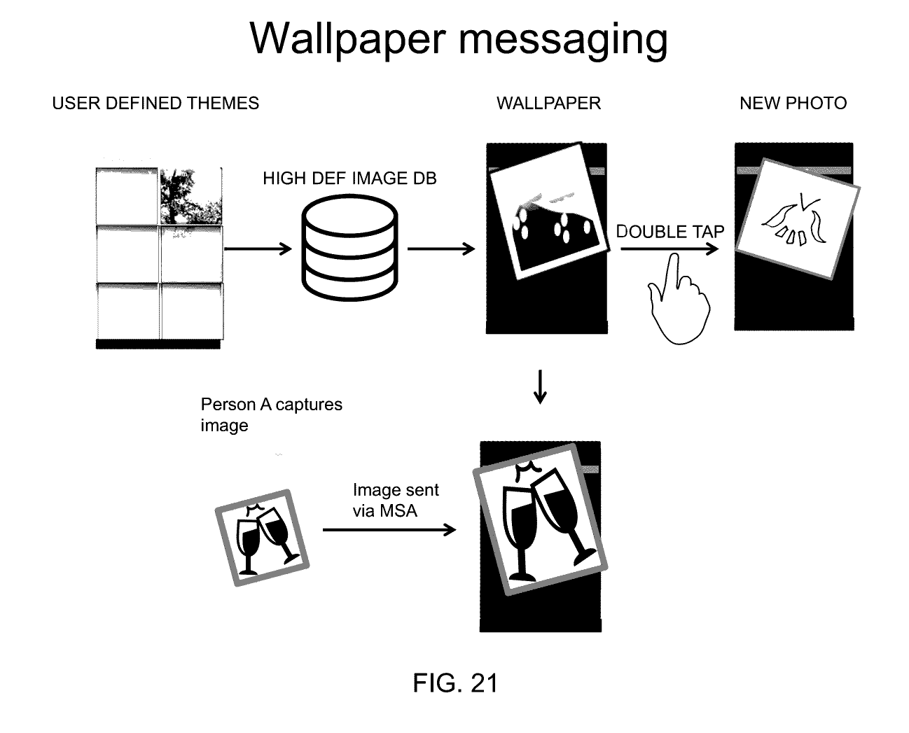

FIG. 21 shows an experience of wallpaper messaging in accordance with some embodiments. On the top row, from left to right, the image on the left is the setting screen where a user can select wallpaper themes. The high definition image database are different online repositories from which high definition images are sourced. The next image is that of a phone with a wallpaper from the database. The rightmost image is that of a phone with another wallpaper from the database which occurred by the user forcing a refresh through a screen gesture. On the bottom row, the left image is that of a person capturing a image, and the right image is that of the wallpaper after the user sends the captured image to their friend thereby changing their wallpaper to the sent image.

FIG. 22 shows a process, performed by the wallpaper manager module, for messaging and drawing new wallpapers in accordance with some embodiments. In this process, the wallpaper manager module is configured to search an external database, enable a user to change his/her friend's wallpaper by sending an image to the friend, automatically choose and load images to be used as a wallpaper, and check that the user visited the home screen and using that information to determine whether the user has seen the image already. The wallpaper manager module is configured to keep track of time and exchange wallpapers when they are due by requesting images from image databases. The wallpaper manager module is also configured to respond to user interactions, including modifying the wallpapers themes, gestures to change the wallpaper, and monitors users viewing of wallpapers to know when they have been viewed. It is also configured to monitor incoming wallpapers and replace the current wallpaper accordingly when this occurs.

In some embodiments, the wallpaper manager module can be configured with custom themes of interest and be configured to retrieve high quality images from a database relating to the configured custom themes. For example, when the wallpaper manager module is configured with a baseball theme, the wallpaper manager module can retrieve baseball related images from the database and use the retrieved images for the wallpaper.

In some embodiments, the wallpaper manager module can be configured to eliminate nude content. For example, for wallpapers, the wallpaper manager module may filter images out that contain hashtags that identify them as being nude or otherwise inappropriate content. In some embodiments, the wallpaper manager module can be configured to retrieve more relevant images for certain image categories (e.g., cars, animals). For example, a hashtag-based filtering method may be used.

In some embodiments, the wallpaper manager module can be configured to customize the image categories based on search terms. For example, when a user provides a search term, the wallpaper manager module can use an image search engine to identify relevant images that can be used for wallpapers.

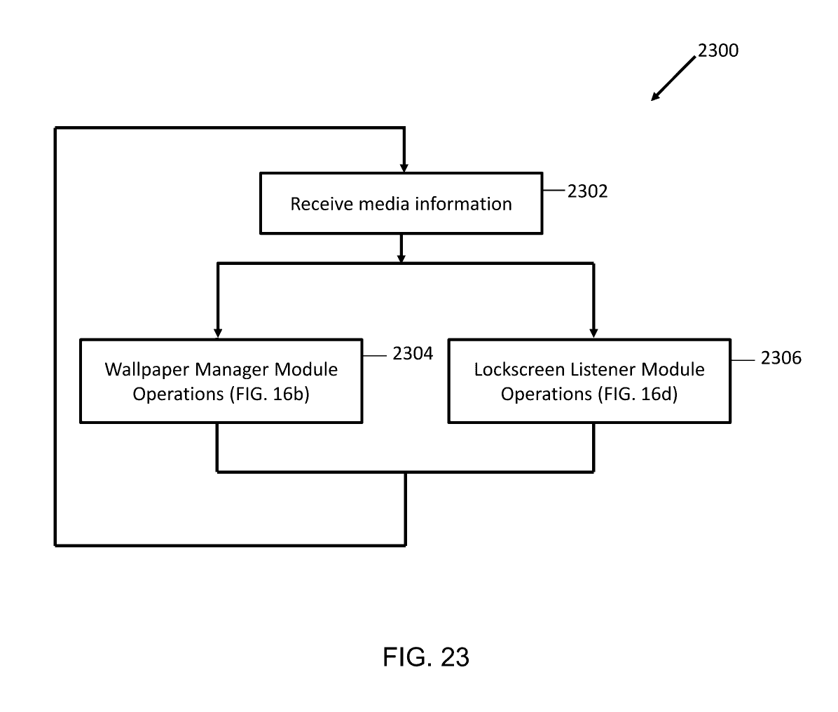

FIG. 23 shows a flow diagram of a process 2300 performed by a mobile device in accordance with some embodiments. In step 2302, the transceiver 206 of the mobile device can receive media information. This media information can be provided to the wallpaper manager module 216 and the lock screen listener module 218. In steps 2304 and 2306, the wallpaper manager module 216 and the lock screen listener module 218 can respectively perform their operations in accordance with FIG. 16, as further illustrated in FIG. 17 and FIG. 18, respectively. This process 2300 can be repeated every time the mobile device receives incoming media information.

It will be appreciated that while several different arrangements have been described herein, that the features of each may be advantageously combined together in a variety of forms to achieve advantage.

In the foregoing specification, the application has been described with reference to specific examples. It will, however, be evident that various modifications and changes may be made therein without departing from the broader spirit and scope of the invention as set forth in the appended claims.

It is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method for providing media information at a mobile device, the method comprising:
receiving, at a lock screen listener module of a mobile device, a notification from a receiver, indicating that media information has been received from a communications network;
in response to receiving the notification, instructing, by the lock screen listener module, a lock screen display module to display the media information above a lock screen on a display of the mobile device; and
providing interactive tools above the lock screen for editing the media information displayed above the lock screen.

2. The method of claim 1, further comprising monitoring a Multimedia Messaging Service (MMS) stack, by the lock screen listener module, to determine whether the media information has been received from the communications network.

3. The method of claim 2, further comprising intercepting a message on the MMS stack to retrieve the media information.

4. The method of claim 1, wherein instructing the lock screen display module to display the media information comprises providing the media information to the lock screen display module.

5. The method of claim 1, wherein the receiver comprises a software application running independently of the lock screen listener module and the lock screen display module.

6. (canceled)

7. The method of claim 6, further comprising sending the edited media information to another mobile device over the communications network.

8. The method of claim 6, further comprising sending the edited media information to a group of mobile devices over the communications network.

9. A mobile device configured to provide media information received from a communications network, the mobile device comprising:
a display configured to display a lock screen and media information;
non-transitory memory storing computer readable instructions associated with a receiver, a lock screen listener module and a lock screen display module;
one or more interfaces for receiving the media information from the communications network; and
a processor in communication with the one or more interfaces and the non-transitory memory, wherein the computer readable instructions are configured to cause the processor to:
receive, at the lock screen listener module, a notification from the receiver, indicating that media information has been received from a communications network;
in response to receiving the notification, instruct, by the lock screen listener module, the lock screen display module to display the media information above the lock screen on the display; and
provide interactive tools above the lock screen for editing the media information displayed above the lock screen.

10. The mobile device of claim 9, wherein the computer readable instructions are configured to cause the processor to monitor a MMS stack, by the lock screen listener module, to determine whether media information has been received from the communication network.

11. The mobile device of claim 10, wherein the computer readable instructions are configured to cause the processor to intercept a message on the MMS stack to retrieve the media information.

12. The mobile device of claim 9, wherein the computer readable instructions are configured to cause the processor to provide the media information to the lock screen display module to instruct the lock screen display module to display the media information above the lock screen on the display.

13. The mobile device of claim 9, wherein the receiver comprises a software application running independently of the lock screen listener module and the lock screen display module.

14. The mobile device of claim 9, wherein the computer readable instructions are configured to cause the processor to instruct the lock screen display module to display the media information over the entire lock screen.

15. (canceled)

16. The mobile device of claim 15, wherein the computer readable instructions are configured to cause the processor to send the edited media information to another mobile device via the one or more interfaces over the communications network.

17. The mobile device of claim 16, wherein the computer readable instructions are configured to cause the processor to send the edited media information to a group of mobile devices via the one or more interfaces over the communications network.

18. A non-transitory computer readable medium having executable instructions for providing media information, wherein the executable instructions are operable to cause a processor of a mobile device to:
receive, at a lock screen listener module of the mobile device, a notification from a receiver, indicating that media information has been received from a communications network;
in response to receiving the notification, instruct, by the lock screen listener module, the lock screen display module to display the media information above a lock screen on a display of the mobile device; and
provide interactive tools for editing the media information displayed above the lock screen.

19. The computer readable medium of claim 18, further comprising executable instructions operable to cause the processor to monitor a MMS stack to determine whether the media information has been received from the communications network.

20. (canceled)
